(19) United States
(12) Patent Application Publication
(10) Pub. No.: US 2007/0168208 A1
(43) Pub. Date: Jul. 19, 2007

(54) LOCATION RECOMMENDATION METHOD AND SYSTEM

(76) Inventors: Ville Aikas, Seattle, WA (US); Arthur Jason Gregory, Seattle, WA (US)

Correspondence Address: AXIOS LAW GROUP, 1725 WESTLAKE AVENUE NORTH, SUITE 150, SEATTLE, WA, 98109, US

(21) Appl. No.: 11/610,094

(22) Filed: Dec. 13, 2006

Related U.S. Application Data
(60) Provisional application No. 60/597,612, filed on Dec. 13, 2005.

(51) Int. Cl. G06Q 99/00

(52) U.S. Cl. 705/1; 705/2

(57) ABSTRACT

A method of recommending a location is provided herein.

### BACKGROUND

Communications between electronic devices have improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term Internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

While the Internet has given rise to new ways of doing research about various establishments, or service providers, most of that information is quite static in its nature and very catered to a user doing research well in advance of visiting the establishment. This is of very little use to the typical user out on the town, who wants to know in real-time where to go to meet like minded people, or find a restaurant or bar that is likely to provide an atmosphere that appeals to them at that very moment. There are a number of search engines that are able to take users approximate location (either based on a zip code, cross streets or address) and then provide a list of establishments and service providers (bars, restaurants, massage parlors, etc.) Lists like this (CitySearch, Google, etc.) currently provide user reviews and a way to rank lists based on those user reviews.

There are several problems relying on the users going through a lengthy process of creating the review. Firstly, you need to do this on a website when you get home, or the next day. Very few people choose to go through this process and hence the reviews tend to be written by a small number of people, who are willing to take the time to create these reviews.

Another problem with these review sites is the inherent trust issue with the reviewers. It's quite difficult to trust the word of anonymous reviewers and not having any information about the kinds of people who are doing the reviews. There have even been numerous reports of owners of establishments writing reviews for their own restaurants or their own services. The user is left with little more choice than to resort to calling friends and family for recommendations whenever plausible. Of course calling all the people for spur of the moment is not always doable (late evening, vacation in a new city, traveling salesman, etc.).

Another problem with the reviews is their static nature. They are extremely slow to change to sudden changes in the popularity of establishments. For example, if a bar or restaurant happens to have a very special promotion or event for one evening only, these websites have no way to gather and alert the user to the changing conditions around him/her. The websites are also unable to create suggestions based on the users current location, weekday and time of day, so a location that is very busy and lively on a Friday evening, might be totally empty on a Thursday evening and vice versa. Or a dance club that is very popular during Fridays, but where the average age is 22, might not appeal to a visiting scholar looking for a dance club where Tango is the dance of choice.

### A BRIEF DESCRIPTION OF DRAWINGS

FIG. 1 illustrates an example System Implementation in accordance with one embodiment.

FIG. 2 illustrates an example user interaction in accordance with one embodiment.

FIG. 3 illustrates a flow diagram of an example of an algorithm used to search for location and service recommendations for a particular search user, in accordance with one embodiment.

### DETAILED DESCRIPTION

Unlike the systems above, in the exemplary embodiments described below, a system is customized and tailored to suggest establishments and services to a user that is applicable in real-time, close to the users current location and takes into account users preferences about the clientele, atmosphere and any other properties about the services.

The system tracks user's current location down to the establishment level using any of a variety of mobile devices, for example GPS receivers, proximity based sensors (Bluetooth, WiFi hotspot, and the like), or relying on users to report their current location using SMS and the like. Using this information the system can provide detailed recommendations based on real-time usage of nearby establishments and services by the community of users.

For example, the system could recommend the most popular nightclub based on the locations of all night club goers over a range of distances. Besides this location information, the system can optionally collect any number of profiles about the user to help make recommendations by matching these user profiles to other users in the system or the locations themselves. A profile can be thought of as a list of attributes or preferences which may or may not apply to a specific domain such as a dating profile, interests profile, or classmates profile, and the like. A profile could be a set of key value pairs ({“age”, 24}, {“sex”, “male”}, {“interest”, “chess”}, {“High School”, “Seattle Lutheran”} and so on).

Another profile could be a key-value-weight tuple, where the weight allows the user to specify how important that particular attribute is. For example, a profile where each key-value is weighted from 0 to 100 where 0 means ‘must not have’ and 100 means ‘must have’ and other numbers are linearly scaled between the two. Such a profile could be used to describe desirable attributes about a nightclub ({“min age”, 18, 50}, {“cover”, “<10”, 100}, {“smoking”, “no”, 100}). A dating profile, for example, could be created to describe the user's attributes (height, weight, sex, sexual preference, and the like) as well as the desired attributes in a potential matching user (min and max age, min and max height, smoking/non-smoking, and the like).

Another example of a profile is the set of attributes that are of particular importance to a user about a particular location (cover charge, full bar, smoking, etc.) This profile could be created a priori to the user actually performing the search for an establishment or a service provider, or it could be constructed based on the user's behavior, or the user could create transient search profiles that would only be applicable to that particular search. For example, the system could match the attributes of locations that the user frequents and then create a profile for a user automatically, or the user could create a profile for a particular search query and filling out the profile parts that are of particular interest right now.

The system can also optionally keep track of other users in the community whose opinions the user respects in certain areas. This once again could be implemented with a key-value-weight tuple ({“food-steak”, “Bob”, 100}, {“food”, “Bill”, 75}, {“hip-club”, “Ben”, 75}, etc.). Previous sample would trust recommendations by “Bob” about steak restaurants higher than those of other people. Furthermore, when searching for hip clubs, recommendations by “Ben” would get ranked higher than those of other ordinary users.

Besides matching the user to the current users visiting an establishment, the system can also optionally keep a history of establishments the community of users visit, and create a profile of the kinds of users likely to be at the establishment at any point in time. The system can match the user against this “typical user profile” to help find establishments to recommend. For example the system could look at the kinds of users that have frequented the establishment in the last four weeks on the same day of the week around the same time of day, and count the users that would have matched the profile(s) of the user performing the search, possibly weighting matches that happened last week higher than others.

In summary, by knowing which users are at which locations at any given time, the system can recommended a location based on real-time information about the locations where the user would be most likely to find like minded individuals (for example, dating purposes, old classmates, shared interests). By keeping history on users locations, the system can also provide recommendations not only on the current patrons of the establishment, but also predict the kinds of people who are likely to be at that location during this time based on past.

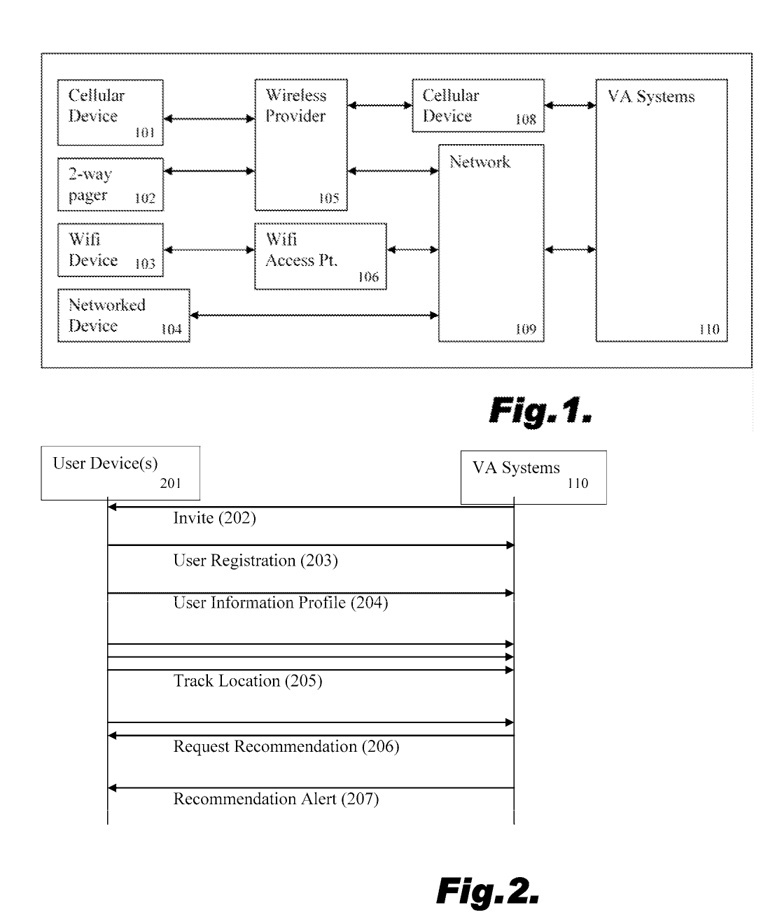

The following is a general description of an example system which implements the functionality described above for recommending locations and services based on real-time usage from a community of mobile users (see FIG. 1).

FIG. 1 illustrates an example System Implementation. At one end of the system are a number of devices, which are used to input information by the users of the system. Users may establish their association with a device. For example, the user may supply a username and password from a cell phone 101 with SMS or from a web page using a laptop 103 at a WiFi hot spot 106 and the system could automatically pair the user with the device. Another example is a web page where a user signs up different addresses for mobile devices, which they will be using, for example phone numbers, email address, network IP address, and the like. There is effectively no limit on the number of devices the user uses to interact with the system. Besides wireless devices like two-way pagers 102, WIFI enabled PDAs 103, cell phones (with varying levels of capabilities (Bluetooth, MMS, SMS, WAP, etc.) 101, and the like, users might use a stationary network enabled device 104 at there current location. An example of a stationary networked device is a user visiting a friends house and using a desktop computer 104 to check for recommendations from that location.

Each of the devices in the system is somehow able to pass information to and from the device to the VA systems 110 (e.g., a server or other device capable of processing the information). These communications are not necessarily in real time. Data may be buffered at any point in the system and later sent or retrieved to or by our VA systems 110 . Some example paths the data may take to VA systems 110 is through a wireless provider 105 such as a cellular carrier, which passes information via a network 109 to VA systems 110 or to another cellular device 108, which is connected to VA systems 110.

Another example is a WIFI Access Point 106 connected via a network 109 to VA systems 110 that can pass data from a WIFI enabled device 103 through a network 109 to VA systems 110.

Using the devices and the data paths described above VA system 110 receives or retrieves data associated with the user. Included in this data is location information for the user. This information maybe transferred in many different ways. An example is a wireless cell carrier 105, which is able to collect the current position of a cellular device 101 within its network using built in GPS in the device or other means such as cell tower triangulation.

Another example is a Bluetooth receiver, which is connected to a wireless provider 105 and records when the user's Bluetooth device (not shown) is present.

Yet another example is message capable cellular 101 or WIFI enabled device 103, which sends email or SMS messages with information about the user's current location. For example, the location name, or address, or longitude and latitude, which may be entered by the user or detected by the device. Using some method the location for the user is recorded by VA systems 110 with varying frequency.

FIG. 2 illustrates an example user interaction. Data flows between any of the users devices 201 and VA systems 110 using methods described earlier. The user may be invited to join VA systems 110 using an invite message 202 prompted by some other event. For example a friend may supply an address to a user's device to invite them to join. The user registers 203 to use the VA system 110, thereby pairing the device 201 to the user. This may or may not be visible to the user. For example, if the device 201 is using SMS to send a message from the user then the address sending the message is paired with the user for all future transmissions.

If the user has multiple devices 201 then the VA systems 110 will implement a method to handle multiple user registrations. For example the user may be prompted for an existing username and password which was previously associated with the user upon registering a previous device and when correctly entered, associate the two devices for the same user. After user registration, the user may optionally submit more information 204 to build a profile of the user's likes and dislikes for locations and other users. This isn't necessarily a one-time event and could be associated with the current known location for the user. Data about the user's current location is transferred to the system while the user is mobile 205. The rate and timeliness of the location data isn't important and may or may not be prompted by an explicit user action.

Location and services recommendations could be requested 206 from VA systems 110 or the user may setup VA systems 110 to alert when a recommendation is nearby 207. In either case the user may supply additional information to use during the recommendation process. For example the user may request that the recommendation be within a certain distance or they may request recommendations for times in the future or for other locations than there current one.

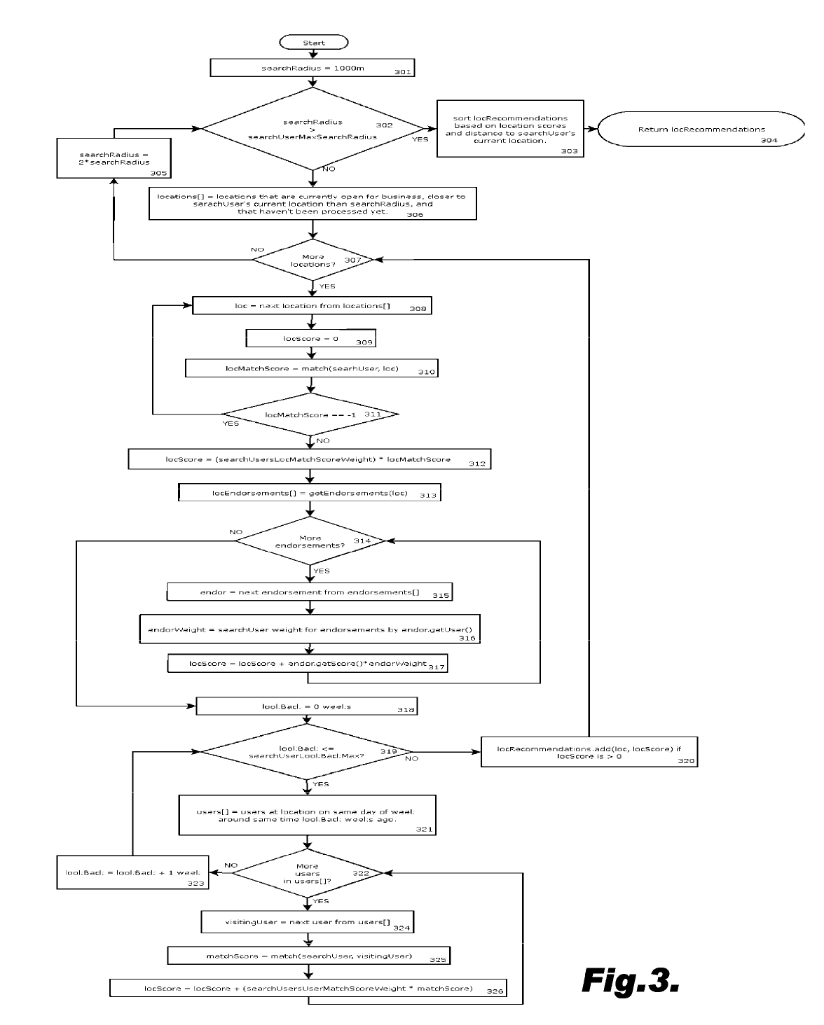

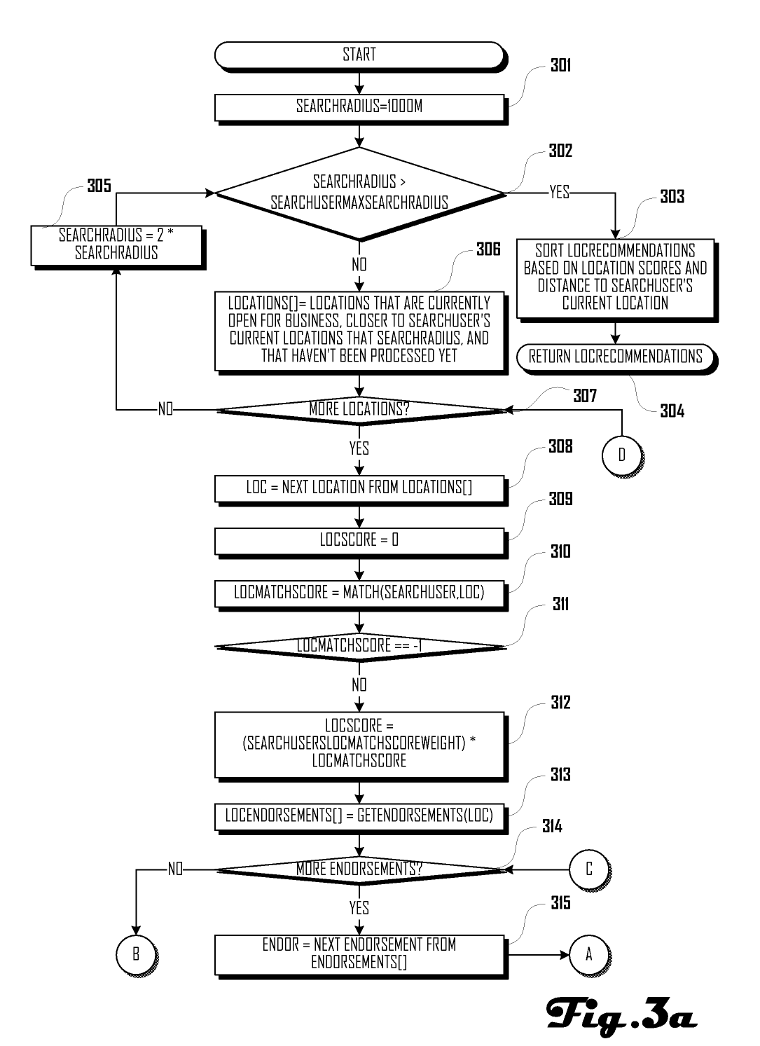

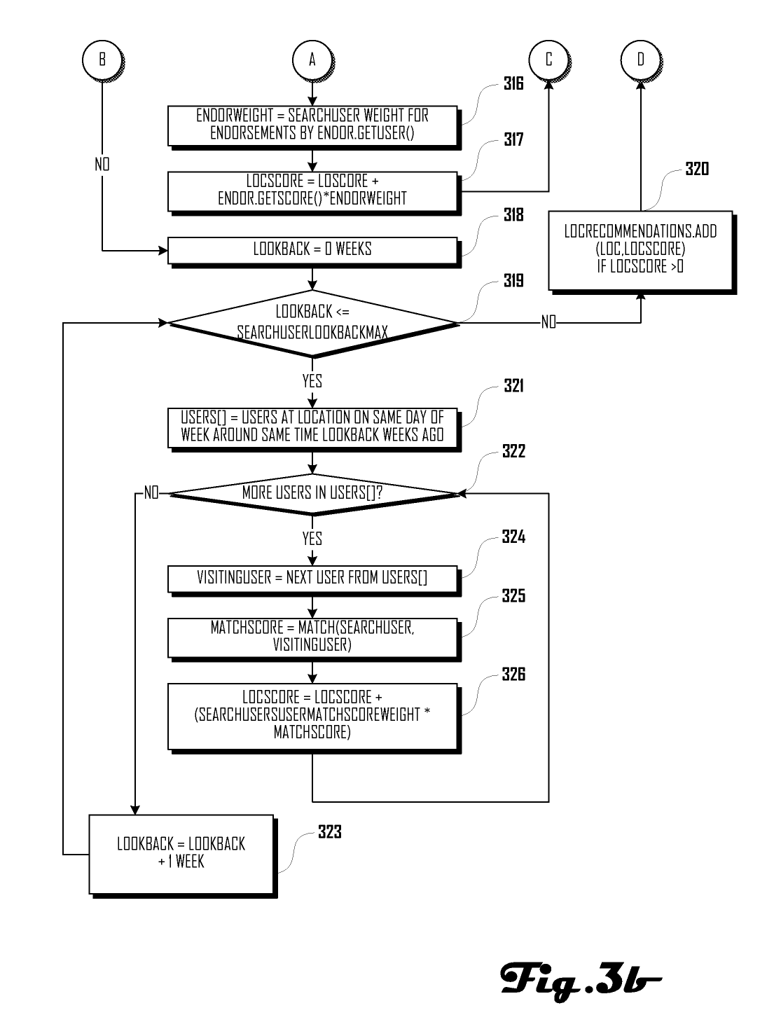

An example of an algorithm used to search for location and service recommendations for a particular search user is outlined in the flow chart shown in FIG. 3. The process starts the search by choosing an arbitrary initial searchRadius 301. This value is less than the searchUserMaxSearchRadius 302, which is the maximum search radius that the search users would like to find recommendations within (a default set by the system or provided by the searchUser for this search or for all searches).

All locations within searchRadius, which are currently open for business, and which have not been processed in the current search already are collected 306 and processed to evaluate if they should be recommended to the search user. For each “loc” in this set of locations 308 the algorithm will start to build a locScore 309, which represents how strong the location recommendation is for the search user.

The first component of the locScore is the locMatchScore, which is the score for how well loc matches the searchUser 310. This score is determined by looking at the location preferences set up by the searchUser against the known attributes for the loc. The stronger the match between preferences and attributes the higher the locMatchScore. If there is an explicit mismatch between the searchUser's preferences and the loc's attributes 311 then the loc is rejected and the algorithm moves on to the next location to process 308. If, however, the loc is matched then the locMatchScore is “weighted” by the searchUsersLocMatchScoreWeight a default set by the system or provided by the searchUser for this search or for all searches) and set as the locScore 312.

Throughout the algorithm additions to locScore are weighted to represent how important that addition is to the searchUser's search. For example if the searchUser doesn't care at all about a certain factor such as the locMatchScore, then it might assign a searchUsersLocMatchScoreWeight=0 or if they care greatly about it then they may assign a higher weight with regard to other weights assigned by the searchUser such as searchUsersUserMatchScoreWeight 326.

After modifying locScore based on the locMatchScore, the algorithm finds all of the user endorsements for loc 313 and processes each one to see how it affects the recommendation. For each of the endorsements 315 the algorithm sets endorweight to a special weight that the searchUser has set for the user making the endorsement or the default weight the searchUser has set for all endorsements 316. For example, if the searchUser doesn't trust the user making the endorsement then they may set the weight to 0 so the endorsement won't have any effect on the locScore 317 or it may negatively affect the score if endorweight is negative.

After all of the endorsements for a loc are accounted for 314 the algorithm will start to look at the visiting history of users for loc. The algorithm looks for user's usage pattern of the loc on the same day of week around the same time of day 321 (where same time of day is an arbitrary number, for example it could be a window of past 3 hours and the next 3 hours) starting from the current week 318 and extending 323 back to searchUserLookBackMax (a default set by the system or provided by the searchUser for this search or for all searches) weeks 319. For each visitingUser found 324 the algorithm will apply a matching process to get a matchScore of how well the visitingUser is matched to the searchUser 325. This process looks at the known preferences for both searchUser and visitingUser to find if those preferences match and if so assigns a score on the strength of the match. For example, if visitingUser only has 2 out of 3 attributes, which match searchUsers preferences, then the matchScore would be less than the matchScore for another visitingUser who has all 3. If a match isn't found then the process returns 0 else it returns some number greater than 0, which will be weighted by the searchUsersUserMatchScoreWeight (a default set by the system or provided by the searchUser for this search or for all searches) and applied to locScore 326. The searchUsersUserMatchScoreWeight is also adjusted for the number of weeks back the visitingUser was found at the location. For example a visitingUser match found on the current day will be weighted higher than a match found 3 weeks ago on the same day of the week.

After accounting for the usage habits by the visiting users for the location the loc will be added to the list of locRecommendation results 320 if a locScore of significance is found (for example if it's greater than 0) and the process will move on to look at the next loc within the current searchRadius 307. If there are no more locations within searchRadius, then the radius is increased 305 and the process is repeated until the searchUserMatchSearchRadius is reached 302. At that point the results in locRecommendations are sorted based on each locations locScore and the distance of the location from the searchUser's current location and returned from the algorithm.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

What is claimed is:

1. A method of recommending a location as shown and described.
